(19) United States
(12) Patent Application Publication
(10) Pub. No.: US 2007/0044124 A1
(43) Pub. Date: Feb. 22, 2007

(54) Mobile electronic device and data processing system utilizing the same

(75) Inventors: Jing Shun Lin, Yilan County (TW); Chao Lien Tsai, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/505,030

(22) Filed: Aug. 15, 2006

(30) Foreign Application Priority Data
Aug. 16, 2005 (TW) TW94127909

(51) Int. Cl. H04N 9/04; H04N 5/225; H04N 7/16

(52) U.S. Cl. 725/62; 348/207.99

(57) ABSTRACT

A mobile electronic device. A capture module captures a plurality of static videos and stores the static videos to a memory. A compile module compiles each static video with at least one specific set to generate a plurality of display data and stores the display data to the memory. A play module reads the display data and generates a multimedia data according to the specific set.

### BACKGROUND OF THE INVENTION

1. Field of the Invention

The present invention relates to a mobile electronic device, and in particular relates to a mobile electronic device for transforming a static video into multimedia data.

2. Description of the Related Art

In recent years, since software is complicated and users require high quality video and audio, CD-discs have be come an means inadequate of storing the high quality video and the high quality audio. Therefore, a digital versatile disk (DVD) has been developed.

The storage capacity of DVD is about 17 GB. Generally a DVD recorder utilizes the MPEG 2 format to process video utilizes Dolby AC-3 to process audio and then stores the processed audio and video on a DVD. The processed video is called a video elementary stream (Video ES). The processed audio is called an audio elementary stream (Audio ES).

To store the Video ES and Audio ES on a DVD, the Video ES and Audio ES is divided into a plurality of packets. The packets of the Video ES are called packetized Video ES (Video PES). The packets of the Audio ES are called packetized Audio ES (Audio PES).

Dynamic video data can be stored on the DVD but static video data (such as still images, or pictures) cannot. Therefore, in a mobile electronic device having a picture taking (static video) function desiring to store pictures on the DVD, a conventional method copies the picture in a computer and then utilizes a transform process to transform the picture into a dynamic video.

Since static video is transformed into dynamic video by the transform process, when a user desires to utilize another computer to transform the static video, the user must carry a disc with the transform process stored thereon and install it on the other computer.

### BRIEF SUMMARY OF INVENTION

Mobile electronic devices are provided. An exemplary embodiment of a mobile electronic device comprises a memory, a capture module, a compile module, and a play module. The capture module captures a plurality of static videos and stores the static videos to the memory. The compile module compiles each static video with at least one specific set to generate a plurality of display data and stores the display data to the memory. The play module reads the display data and generates a multimedia data according to the specific set.

An exemplary embodiment of a data processing system comprising a mobile electronic device, a connection device, and an external device is also provided. The mobile electronic device comprises a memory, a capture module, a compile module and a play module. The capture module captures a plurality of static videos and stores the static videos to the memory. The compile module compiles each static video with at least one specific set to generate a plurality of display data and stores the display data to the memory. The play module reads the display data and generates a multimedia data according to the specific set. The connection device is coupled to the mobile electronic device for transmitting the multimedia data. The external device is coupled to the connection for receiving the multimedia data.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a block diagram of an embodiment of a data processing system; and

FIG. 2 is a block diagram of an embodiment of the compile module 23.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

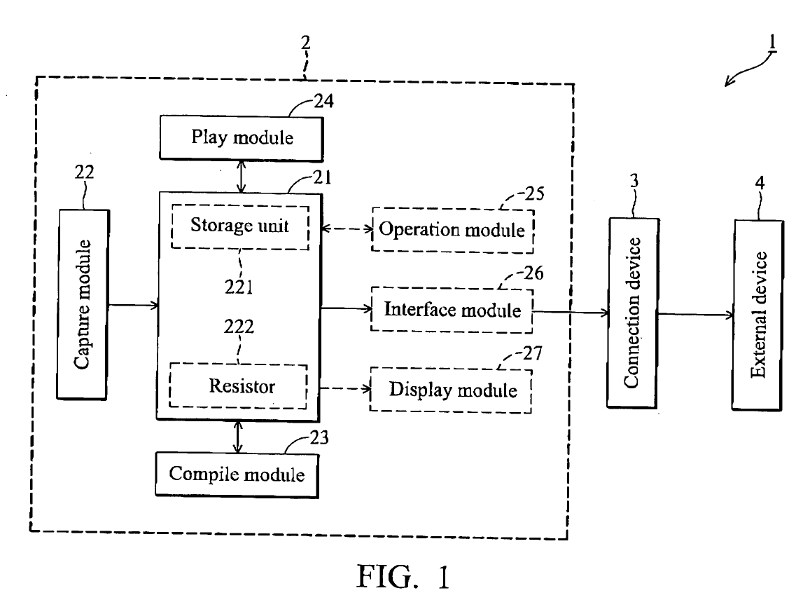

FIG. 1 is a block diagram of an embodiment of a data processing system. The data processing system 1 comprises a mobile electronic device 2, a connection device 3, and an external device 4.

Mobile electronic device 2 comprises a memory 21, a capture module 22, a compile module 23, and a play module 24. Capture module 22 captures a plurality of static videos and is capable of storing the static videos to memory 21. Compile module 23 compiles each static video with at least one specific set, generates a plurality of display data and stores the display data to memory 21. Play module 24 reads the display data stored in memory 21 and generates a multimedia data according to the specific set.

Connection device 3 is coupled between mobile electronic device 2 and external device 4 for transmitting the multimedia data to external device 4. Connection device 3 is an IEEE 1394 connection line, a USB connection line, or a TV connection line.

External device 4 acts as a recorder or a display device. When external device 4 acts as the recorder, such as a digital versatile disc (DVD) recorder, the recorder can directly record the multimedia data generated by mobile electronic device 2 into a DVD. When external device 4 acts as the display device, the display device can display the multimedia data.

Mobile electronic device 2 further comprises an operation module 25 utilizing MPEG to compress or un-compress the static videos and the display data stored in memory 21.

Operation module 25 compresses the static videos captured by capture module 22 and stores the compressed static videos to storage unit 221 of memory 21. When compile module 23 compiles the static videos captured by capture module 22, operation module 25 un-compresses the compressed static videos stored in storage unit 221. The un-compressed static videos are stored in resistor 222 of memory 21.

Compile module 23 reads the un-compressed static videos and compiles the un-compressed static videos with a specific set. The compiled static videos are called display data. Operation module 25 compresses the display data and stores the compressed display data to storage unit 221.

When play module 24 reads the display data, operation module 25 un-compresses the compressed display data stored in storage unit 221 and stores the un-compressed display data to resistor 222. Play nodule 24 generates a multimedia data according to the specific set comprised in the display data.

A user utilizes interface module 26, such as an IEEE 1394 interface, a USB interface, or a TV interface, to output the multimedia data to connection device 3. The specification of interface module 26 must correspond to that of connection device 3.

Additionally, a user can directly view the multimedia data generated by play module 24 as mobile electronic device 2 comprises a display module 27.

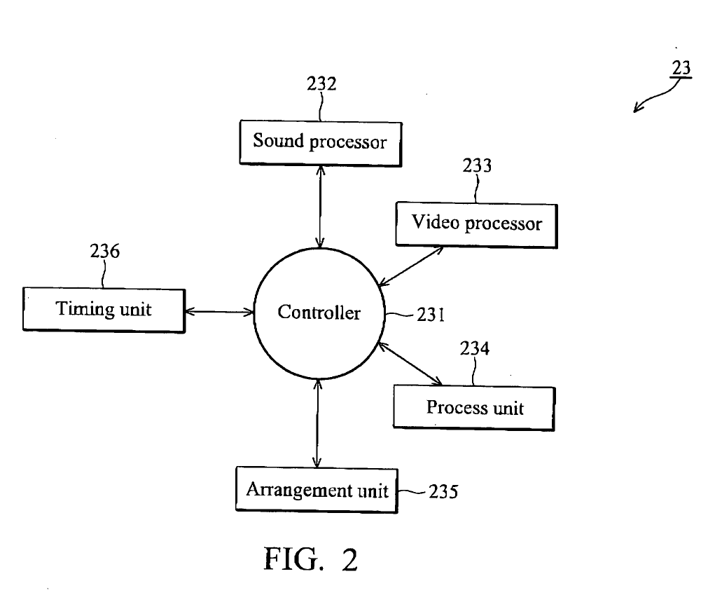

FIG. 2 is a block diagram of an embodiment of the compile module 23. Compile module 23 comprises a controller 231, a sound processor 232, video processor 233, process unit 234, an arrangement unit 235, or a timing unit 236.

Controller 231 edits each static video with a corresponding specific set. The specific sets may be the same or different.

Sound processor 232 provides a specific sound to controller 231. Controller 231 edits a static video with the specific sound and transforms the specific sound and the static video into a display data. When play module 24 reads the display data, the static video and the specific sound are simultaneously played. Therefore, the display data can be called a multimedia data.

Video processor 233 provides a picture to controller 231. Controller 231 edits a static video with the picture and transforms the picture and the static video into a display data. When play module 24 reads the display data, the static video and the picture are displayed at the same time. Therefore, the display data can be called a multimedia data.

Process unit 234 provides a specific process, such as a fade-in fade-out process, to controller 231. Controller 231 edits a static video with the specific process and transforms the specific process and the static video into a display data When play module 24 reads the display data, the static video is played according to the specific process. Therefore, the display data can be called a multimedia data.

Arrangement unit 235 provides a display order to controller 231. Controller 231 edits a static video with the display order and transforms the display order and the static video into a display data. When play module 24 reads a plurality of the display data, each having the display order, the static videos are played according to the corresponding display order. Therefore, the display data can be called a multimedia data

Timing unit 236 provides an intermission time to controller 231. Controller 231 edits a static video with the intermission time and transforms the intermission time and the static video into a display data. When play module 24 reads a plurality of the display data, each having the intermission time, the static videos are played according to the corresponding intermission time. Therefore, the display data can be called a multimedia data

Controller 231 can edit a static video with multi-specific sets, such as a specific sound, a specific process, a display order, and an intermission time, and transforms the static video with multiply specific sets into a display data. Play module 24 reads a plurality of the display data and plays the display data, transformed from the static videos with multi-specific sets, according to multiply specific sets edited in each display data. The display data in process of being played is called a multimedia data.

The advantages of the invention are summarized in the following. Processes of editing and transforming are directly executed in a mobile electronic device rather than through a computer. After static videos respectively with multiply specific sets are transformed into a multimedia data, the multimedia data can be recorded on a DVD. The multimedia data can be played on an external device or directly played on the mobile electronic device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile electronic device, comprising:
a memory;
a capture module for capturing a plurality of static videos and storing the static videos to the memory;
a compile module for compiling each static video with at least one specific set to generate a plurality of display data and store the display data to the memory; and
a play module reading the display data and generating a multimedia data according to the specific set.

2. The mobile electronic device as claimed in claim 1, further comprising a display module for displaying the multimedia data.

3. The mobile electronic device as claimed in claim 1, further comprising an interface module for outputting the multimedia data to an external device.

4. The mobile electronic device as claimed in claim 3, wherein the interface module is a IEEE 1394 interface, a USB interface, or a TV interface.

5. The mobile electronic device as claimed in claim 3, wherein the external device is a recorder or a display device.

6. The mobile electronic device as claimed in claim 5, wherein the recorder is a digital versatile disc (DVD) record for recording the multimedia data

7. The mobile electronic device as claimed in claim 5, wherein the display device is a liquid crystal display or a television for displaying the multimedia data.

8. The mobile electronic device as claimed in claim 1, wherein the compile module comprises a controller for editing the specific set in the corresponding static video.

9. The mobile electronic device as claimed in claim 8, wherein the compile module further comprises a sound processor for providing a specific sound to the controller.

10. The mobile electronic device as claimed in claim 8, wherein the compile module further comprises a video processor for providing a picture to the controller.

11. The mobile electronic device as claimed in claim 8, wherein the compile module further comprises a process unit for providing a specific process to the controller.

12. The mobile electronic device as claimed in claim 11, wherein the specific process is a fade-in fade-out process.

13. The mobile electronic device as claimed in claim 8, wherein the compile module further comprises an arrangement unit for providing a display order to the controller.

14. The mobile electronic device as claimed in claim 8, wherein the compile module further comprises a timing unit for providing an intermission time to the controller.

15. The mobile electronic device as claimed in claim 1, further comprising an operation module for compressing or un-compressing the static videos and the display data

16. The mobile electronic device as claimed in claim 15, wherein the operation module utilizes MPEG to compress or un-compress the static videos and the display data.

17. The mobile electronic device as claimed in claim 15, wherein the memory comprises:
a storage unit for storing the compressed static videos and the compressed display data; and
a register for storing the un-compressed static videos and the un-compressed display data

18. The mobile electronic device as claimed in claim 17, wherein the compressed static videos and the compressed display data stored in the storage unit is un-compressed when the compile module or the display module desires to read the static videos or the display data.

19. The mobile electronic device as claimed in claim 17, wherein the un-compressed static videos and the un-compressed display data stored in the register is compressed when the capture module or the compile module desires to store the static videos or the display data.

20. A data processing system, comprising:
a mobile electronic device comprising:
a memory;
a capture module for capturing a plurality of static videos and storing the static videos to the memory;
a compile module for compiling each static video with at least one specific set to generate a plurality of display data and store the display data to the memory; and
a play module reading the display data and generating a multimedia data according to the specific set
a connection device coupled to the mobile electronic device for transmitting the multimedia data; and
an external device coupled to the connection for receiving the multimedia data.

21. The data processing system as claimed in claim 20, wherein the mobile electronic device further comprises a display module for displaying the multimedia data.

22. The data processing system as claimed in claim 20, wherein the mobile electronic device further comprises an interface module for outputting the multimedia data to the connection device.

23. The data processing system as claimed in claim 22, wherein the interface module is a IEEE 1394 interface, a USB interface, or a TV interface

24. The data processing system as claimed in claim 23, wherein the connection device is an EEEE 1394 connection line, a USB connection line, or a TV connection line.

25. The data processing system as claimed in claim 20, wherein the external device is a recorder or a display device.

26. The data processing system as claimed in claim 25, wherein the recorder is a digital versatile disc (DVD) record for recording the multimedia data.

27. The data processing system as claimed in claim 25, wherein the display device is a liquid crystal display or a television for displaying the multimedia data.

28. The data processing system as claimed in claim 20, wherein the compile module comprises a controller for editing the specific set in the corresponding static video.

29. The data processing system as claimed in claim 28, wherein the compile module further comprises a sound processor for providing a specific sound to the controller

30. The data processing system as claimed in claim 28, wherein the compile module further comprises an video processor for providing a picture to the controller.

31. The data processing system as claimed in claim 28, wherein the compile module further comprises a process unit for providing a specific process to the controller.

32. The data processing system as claimed in claim 21, wherein the specific process is a fade-in fade-out process.

33. The data processing system as claimed in claim 28, wherein the compile module further comprises an arrangement unit for providing a display order to the controller.

34. The data processing system as claimed in claim 28, wherein the compile module further comprises a timing unit for providing an intermission time to the controller.

35. The data processing system as claimed in claim 20, wherein the mobile electronic device further comprises an operation module for compressing or un-compressing the static videos and the display data.

36. The data processing system as claimed in claim 35, wherein the operation module utilizes MPEG to compress or un-compress the static videos and the display data.

37. The data processing system as claimed in claim 35, wherein the memory comprises:
a storage unit for storing the compressed static videos and the compressed display data; and
a register for storing the un-compressed static videos and the un-compressed display data.

38. The data processing system as claimed in claim 37, wherein the compressed static videos and the compressed display data stored in the storage unit is un-compressed when the compile module or the display module desires to read the static videos or the display data.

39. The data processing system as claimed in claim 27, wherein the uncompressed static videos and the un-compressed display data stored in the register is compressed when the capture module or the compile module desires to store the static videos or the display data.
